(19) United States
(12) Patent Application Publication
(10) Pub. No.: US 2020/0095987 A1
(43) Pub. Date: Mar. 26, 2020

(54) CONTROL APPARATUS FOR SUPPLYING AT LEAST ONE HYDRAULIC CONSUMER WITH FLUID

(71) Applicant: HYDAC SYSTEMS & SERVICES GMBH, Sulzbach/saar (DE)

(72) Inventors: Heinz-Peter HUTH, Ueberherrn (DE); Marc ANTON, Voelklingen (DE)

(21) Appl. No.: 16/497,013

(22) PCT Filed: Apr. 27, 2018
(86) PCT No.: PCT/EP2018/060866

§ 371 Date: Sep. 24, 2019

(30) Foreign Application Priority Data
May 15, 2017 (DE) 10 2017 004 634.4

(51) Int. Cl. F04B 49/00; F15B 11/16

(52) U.S. Cl. CPC F04B 49/002; F15B 11/165; F04B 49/007; F15B 2211/20576; F15B 2211/2652; F15B 2211/45; F15B 2211/20546

(57) ABSTRACT

The invention relates to a control apparatus for supplying at least one hydraulic consumer with fluid having a variable displacement pump (10) which may be controlled by means of a loadsensing pressure (LS), characterized in that, for a case-by-case increase in the volume flow in the supply (22) to the hydraulic consumer, the loadsensing pressure (LS) is passed via a control line (28) to a control device (2) which ensures the increase in the supply (22) by connecting in a constant-displacement pump (16) as soon as an operator calls for the relevant function by operating the control device (2).

The invention relates to a control device for supplying at least one hydraulic consumer with fluid, having a variable displacement pump controllable by means of a load-sensing pressure.

Load-sensing systems that make it possible to adapt the pressure and/or flow rate of a hydraulic pump to the conditions demanded by the consumer, are state of the art, cf. “Wikipedia. The Free Encyclopedia”, chapter Load-Sensing, As is known, LS systems can be designed as so-called open-center systems having fixed displacement pumps or as so-called closed-center systems having variable displacement pumps, as is the case with the above-mentioned control device forming the subject of the application. Because of their energy-saving operation, LS systems are advantageously used to control components of the power hydraulics of mobile work equipment. Such equipment, such as agricultural tractors or equipment for soil cultivation, usually have several hydraulic consumers, such as traction drive, power steering, lifting drives and the like. During operation of such equipment, not all of the consumers present have to be supplied with full volume flow during typical phases of operation at the same time, i.e., among other things, for reasons of cost, the variable displacement pump, conventionally designed as a swing pump, does not have to be designed for the flow rate occurring in exceptional situations. In special or extreme work situations, for example when using a tractor for fieldwork, this can result in an undersupply during maneuvers at the headland, where in addition to the traction drive, steering and machine devices, lifting drives may simultaneously request maximum flow.

Based on this problem, the invention addresses the problem of providing a control device of the type mentioned, which ensures a particularly reliable supply of hydraulic consumers.

According to the invention, this object is achieved by a control device having the features of claim 1 in its entirety.

According to the characterizing part of claim 1, a significant feature of the invention is that, for a case-by-case increase of the volume flow in the inlet of the hydraulic consumer, the load sensing pressure is transmitted to a control device, which increases the inlet [flow] by connecting a fixed displacement pump as soon as an operator initiates the pertinent function by operating the control device, via a control line, Thus, the invention not only provides a kind of boost function for extreme work situations, but simultaneously provides a safeguard against a possible risk to occupational safety, which can be caused by an abrupt change in in-service behavior when the fixed displacement pump is turned on. Because the increase in the incoming volume flow depends on the actuation of the control device to be performed by the operator, the risk that changes in performance will occur that have not been anticipated by the operator, such as changed steering angles, accelerated driving or lifting movements, is avoided because the operator has to activate the boost function.

The control device can advantageously have a first and a second control valve, of which the first control valve of the load sensing pressure in the control line and the second control valve can be controlled by the operator.

In preferred exemplary embodiments, the first valve is a proportional valve, in particular a 2/2 way proportional valve, one control side of which is pressurized with, besides a spring pre-load, the load sensing pressure and the other control side of which is pressurized with the inlet pressure in the inlet of the individual hydraulic consumer.

Advantageously, an electromagnetically actuated switching valve, in particular a 2/2-way switching valve, is provided as a second valve to be actuated by the operator, which opens a fluid path from the fixed displacement pump to a storage tank in its unactuated position and in its operator-actuated position, the relevant fluid path is blocked, such that in this actuated state, the volume flow of the fixed displacement pump is available to increase the inlet [flow].

In this case, the second valve can form a bypass of the first valve by connecting the input and the output of the first valve in a fluid-conveying to the input and the output of the second valve, respectively.

The output of the fixed displacement pump can be connected to the inputs of the first and second valves aria a branch-off point.

To supply the volume flow of the fixed displacement pump to the inlet, the inlet of the fixed displacement pump can be connected to the output of the variable displacement pump via a connecting line, in which a check valve is installed, in particular in the form of a spring-loaded check valve, which opens in the direction of the variable displacement pump and closes in the direction of the fixed displacement pump.

In the connection between the variable displacement pump and the relevant hydraulic consumer, the connecting line including the check valve can be connected first, and subsequently a control line, which pressurizes the first valve with the inlet pressure.

To protect the fixed displacement pump, a pressure limiting valve is installed in a bypass line in parallel to the second control valve; when triggered, the volume flow of the fixed displacement pump is transmitted to the storage tank, bypassing the first and second valves.

With particular advantage, the control device may be formed as a control block, which includes the first and the second valve, the check valve and the pressure relief valve and which has ports for the fluid-conveying connection of the variable displacement pump acting as a swing angle pump, the fixed displacement pump, the relevant consumer, the storage tank and the load sensing control line.

Below the invention is explained in detail using an exemplary embodiment shown in the drawing.

In the drawings:

FIG. 1 shows a symbol representation of the circuit of the exemplary embodiment of the control device according to the invention, wherein the operating state is shown for an LS signal not signaling demand and for a non-actuated control device;

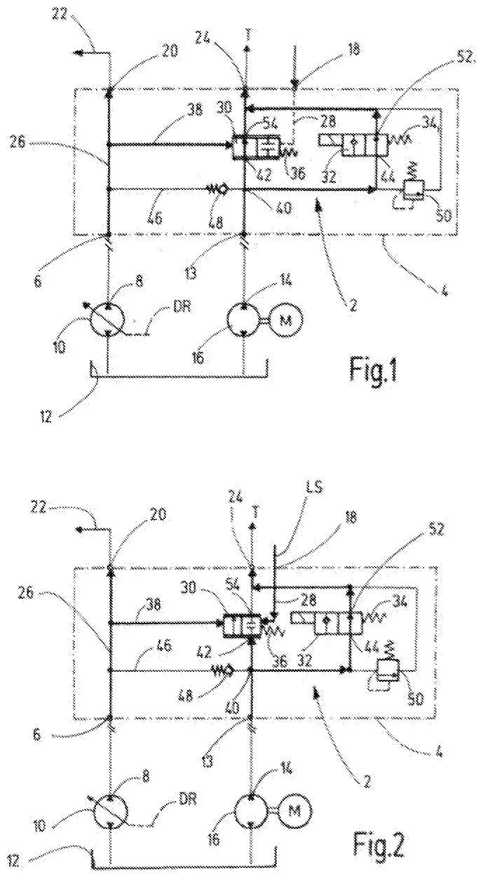

FIG. 2 shows a representation corresponding to FIG. 1, wherein the operating state is shown for an LS signal signaling demand and for a non-actuated control device;

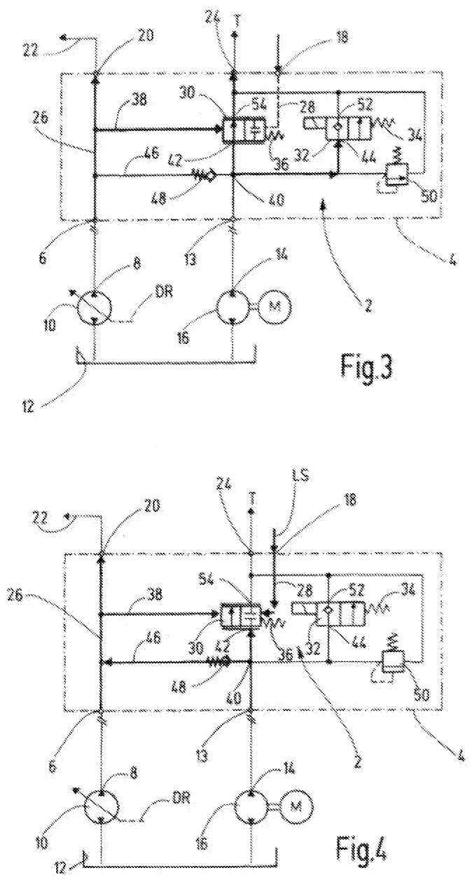

FIG. 3 shows a representation corresponding to FIGS. 1 and 2, wherein the operating state is shown for an LS signal not signaling demand and for an actuated control device; and

FIG. 4 shows a representation corresponding to FIGS. 1 to 3, wherein the operating state is shown for an LS signal signaling demand and for an actuated control device.

The control device according to the invention has a control unit, designated by 2 in the figures, the components of which have been combined to form a control block 4. The control block 4 has a first input port 6, which is connected to the output 8 of a variable displacement pump in the form of a swing pump 10, which is connected to a storage tank 12 on the input side. A second input port 13 of the control block 4 is connected to the output 14 of a fixed displacement pump 16, which, like the swing pump 10, can be motor-driven and is connected to the storage tank 12 on the input side. in the present example, the fixed displacement pump 16 is formed by a gear pump. A demand signal LS signal can be transmitted to a third input terminal 18 of the control block 4, more precisely, in the case of several consumers to be supplied, the highest occurring LS signal is supplied via shuttle valves. A first output port 20 on the control block 4 is routed to the consumer inlet 22, and a second outlet port 24 is routed to the storage tank 12.

The swing pump 10 is part of a closed-center system, otherwise not shown, i.e., the swing angle is adjusted via a pressure regulator DR according to the LS signal. To illustrate the course of the oil flows, resulting in the different operating conditions illustrated in FIGS. 1 to 4, the lines routed to the oil flow lines have been drawn using thicker line thickness. In the control block 4, a supply line is designated by 26, which is routed from the first input terminal 6 to the first output terminal 20 and thus to the inlet 22. A control line, which supplies the LS pressure from the third input port 18 to the control device 2, is designated by 28, As further components, the control block 4 includes a first control valve 30 and a second control valve 32, of which the first valve 30 is a 2/2-way proportional valve and the second valve 32 is a 2/2-way switching valve. The latter can be, activated by an operator, actuated electromagnetically, and it can be brought from an unactuated switching position corresponding to the flow position to an actuated switching position, in which the valve 32 is locked against the force of a return spring 34. The first valve 30 is pressurized on the one hand by a compression spring 36 and by the individual LS-pressure, supplied via the control line 28, and on the other hand pressurized by the inlet pressure present in the supply line 26 via a further control line 38. The output 14 of the fixed displacement pump 16 is connected to the input 42 of the first valve 30 and to the input 44 of the second valve 32 via the second input connection 13 and via a branching point 40. As a result, a fluid path to the second output port 24 of the control block 4 and thus to the storage tank 12 is open from the outlet 14 of the fixed displacement pump 16 if the second valve 32 is in the unactuated switching position. When the second valve 32 is in non-actuated switching position, the volume flow of the fixed displacement pump 16 is discharged to the, tank without restriction.

The output 14 of the fixed displacement pump 16 is also connected to the supply line 26, routed from the swing pump 10 to the inlet 22 via a connecting line 46, wherein a check valve 48 is installed in the connecting line 46, which check valve opens in the direction of the supply line 26. This connecting line 46 is connected to the supply line 26, viewed in the flow direction, upstream of the control line 38. The first valve 30 and the second valve 32 are connected to the second output port 24 of the control block 4 and thus to the storage tank 12 on the output side. The control block 4 is completed by a pressure limiting valve 50, which secures the fixed displacement pump 16 to the storage tank 12 and is inserted as a bypass to the second valve 32 between its input 44 and its outlet 52 connected to the tank.

FIG. 1 shows an operating state in which the second valve 32 is in the unactuated switching position, that is to say the open position. Thus regardless of the valve position of the first valve 30, as mentioned, the volume flow of the fixed displacement pump 16 is routed from the branch point 40 to the tank. In the state of FIG. 1, the first valve 30 is also not pressurized by an LS pressure signaling demand via the line 38. The first valve 30, which forms the pressure compensator of an open-center system in conjunction with the fixed displacement pump 16, is therefore controlled by the supply pressure of the swing pump 10 present in the control line 38 against the action of the compression spring 36 from the blocked position, such that in this state a fluid path is formed to the tank, also via the output 54 of the first valve 30. In FIG. 1, this oil flow is illustrated using thicker lines.

FIG. 2 shows an operating state, in which the fixed displacement pump 16 likewise does not contribute to increasing the inlet volume, because the second valve 32 is again not actuated, i.e., the volume flow of the fixed displacement pump 16 is diverted to the tank. In contrast to FIG. 1, however, an LS pressure is effective at the first valve 30, which signals the need for an additional supply of the inlet 22. In conjunction with the action of the compression spring 36, therefore, the first valve 30 is actuated into the locked state. Although no volume of the swing pump 16 flows through the valve 30, but as the second valve 32 is not actuated, this valve is used for discharging purposes, such that the fixed displacement pump 16 again does not contribute to the supply.

In the operating state of FIG. 3, the operator switches the second valve 32 into the blocking state, i.e., 32 no volume flows out of the fixed displacement pump 16 via this valve. At the same time, however, no LS pressure acts on the first valve 30 via the control line 28, which would be sufficient to actuate the first valve 30 against the supply pressure acting on the control line 38 into the blocking position, such that the proportional valve 30 permits a flow to the tank. Despite the actuated second valve 32, therefore, no boost function is activated.

In the state shown in FIG. 4, an LS-pressure is effective on the first valve 30 via the control line 28, which signals an additional supply, such that the first valve 30 is actuated into the blocking position. At the same time, the operator activates the boost function by actuating the second valve 32 into the blocking position. In these valve positions, the entire volume flow of the fixed displacement pump 16 is fed into the supply line 26 via the branch point 40, the first check valve 48 ant the connecting line 46 and increases the volume flow in the inlet 22.

Because the boost function can only be activated, even if the LS pressure requests an additional supply and thus the first valve 30 is blocked, as shown in FIG. 2, if the operator, as shown in FIG. 4, actuates the second valve 32, the invention provides a safety-enhancing hydraulic lock of the boost function.

1. A control device for supplying at least one hydraulic consumer with fluid, having a variable displacement pump (10) controllable by means of a load-sensing pressure (LS), characterized in that for a case-by-case increase of the volume flow in the inlet (22) of the hydraulic consumer, the load-sensing pressure (LS) is transmitted to a control device (2), which performs the increase in the inlet (22) by connecting a fixed displacement pump (16) as soon as an operator activates the pertinent function by actuating the control device (2), via a control line (28).

2. The control device according to claim 1, characterized in that the control device (2) has a first (30) and a second control valve (32), of which the first control valve (30) can be actuated by the load-sensing pressure (LS) in the control line (28) and the second control valve (32) can be actuated by the operator.

3. The control device according to claim 1, characterized in that the first valve is a proportional valve, in particular a 2/2-way proportional valve (30), one control side of which is pressurized with, besides a spring pre-load (36), the load sensing pressure (LS) and the other control side of which is pressurized with the inlet pressure in the inlet (22) of the individual hydraulic consumer.

4. The control device according to claim 1, characterized in that the second valve is an electromagnetically operable switching valve, in particular a 2/2-way switching valve (32), which, in its unactuated position, opens a fluid path from the fixed displacement pump (16) to a storage tank (12, T) and in its operator-actuated activating position blocks the pertinent fluid path.

5. The control device according to claim 1, characterized in that the second valve (32) is arranged in the bypass of the first valve (30), in which the input (42) and the output (54) of the first valve (30) are connected to the input (44) and the output (52) of the second valve (32) in a fluid-conveying manner.

6. The control device according to claim 1, characterized in that the output (14) of the fixed displacement pump (16) is connected to the input (42 or 44) of the first (30) and the second valve (32) via a branching point (40).

7. The control device according to claim 1, characterized in that the output (14) of the fixed displacement pump (16) is connected to the output (8) of the variable displacement pump (10) via a connecting line (46), in which a check valve is installed, in particular in the form of a spring-loaded check valve (48), which opens in the direction of the variable displacement pump (10) and closes in the direction of the fixed displacement pump (16).

8. The control device according to claim 1, characterized in that first the connecting line (46) having the check valve (48) and subsequently a control line (38) are installed in the connection (26) between the variable displacement pump (10) and the respective hydraulic consumers, which control line pressurizes the first valve (30) with the inlet pressure.

9. The control device according to claim 1, characterized in that a pressure limiting valve (50) is installed in a bypass line in parallel to the second control valve (32); which, upon being triggered, transmits the volume flow of the fixed displacement pump (16) to the storage tank (12, T), bypassing the first (30) and second valves (32).

10. The control device according to claim 1, characterized in that it is formed as a control block (4) which includes
the first (30) and the second valve (32)
the check valve (48), and
the pressure relief valve (50),
which has ports (6, 13, 20, 24, 18) for the fluid-conveying connection of the variable displacement pump acting as a swing angle pump (10), the fixed displacement pump (16), the relevant consumer, the storage tank (12, T) and the load-sensing control line (28).
